(19) United States
(12) Patent Application Publication
(10) Pub. No.: US 2007/0226627 A1
(43) Pub. Date: Sep. 27, 2007

(54) Methods and systems for signal analysis

(76) Inventors: Per Kangru, Fredriksberg (DK); Juergen Voss, Wiesbaden (DE)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/389,129

(22) Filed: Mar. 24, 2006

(51) Int. Cl. G06F 9/00

(52) U.S. Cl. 715/733; 715/736; 715/735; 715/764

(57) ABSTRACT

Graphical user interfaces, methods and systems that enable the selection and grouping of data.

### BACKGROUND OF THE INVENTION

As the use of networks increases, especially in telecommunications, network system providers face conflicting demands from the customer, who demands increase network reliability and performance, and from the business environment, which is sensitive to the cost of operating and maintaining the higher level of service. In order to satisfy or balance those demands, network analysis systems have been developed to facilitate the planning, troubleshooting, installing, and maintaining present-day networks.

Many network analysis systems have a graphical user interface that displays data in the network grouped by data session or by independent network events. A number of these groups can be displayed along with characteristics of the data. The display enables the identification of errors. In conventional network analysis systems, it is possible to the display information corresponding to communication events in a network communications session. In conventional network analysis systems, it is also possible to display a phase graph view in which every symbol relates to a single protocol messages However, in conventional network analysis systems, in case of a network communications session with a long duration or with significant signaling activity, too many phase graphs symbols appear in the display and the phase graph view is no longer effective and obscures other displayed data. Therefore, there is a need for improved graphical user interfaces.

### SUMMARY OF THE INVENTION

In one instance, the graphical user interface of this invention includes a component capable of a component capable of selecting one summary of data from the plurality of summaries of data corresponding to a network communication session, a component capable of selecting a plurality of events corresponding to the selected summary of data; and, an icon representing a portion of a graphical report corresponding to the plurality of selected events.

In one instance, a computer readable medium has computer readable code embodied therein that causes a computer to implement the graphical user interface of this invention. In another embodiment, the computer readable code can also cause a computer to select the one summary of data according to a predetermined criterion or according to user input.

Methods and systems for implementing the present invention are also disclosed.

For a better understanding of the present invention, together with other and further objects thereof, reference is made to the accompanying drawings and detailed description and its scope will be pointed out in the appended claims.

### BRIEF DESCRIPTION OF THE DRAWINGS

FIG. 1 is a graphical depictions of a user interface in a conventional network analysis system;

FIG. 2 is a graphical depiction of an embodiment of the user interface of this invention;

FIG. 3 is a graphical depiction of an embodiment of a component of the user interface of this invention;

FIG. 4 is a graphical schematic representation of a flowchart of an embodiment of the method of this invention; and

FIG. 5 is a graphical schematic representation of a block diagram of an embodiment of the system of this invention.

### DETAILED DESCRIPTION OF THE INVENTION

In one instance, the graphical user interface of this invention includes a component capable of a component capable of selecting one summary of data from the plurality of summaries of data corresponding to a network communication session, a component capable of selecting a plurality of events corresponding to the selected summary of data; and, an icon representing a portion of a graphical report corresponding to the plurality of selected events.

In another instance, a computer readable medium has computer readable code embodied therein that causes a computer to implement the graphical user interface of this invention. In another embodiment, the computer readable code can also cause a computer to select the one summary of data according to a predetermined criterion or according to user input.

“Component” as used herein refers to means for accomplishing a desired function. Typically, such means as implemented in software. In one instance, such means are means for displaying data in graphical user interfaces (GUIs) such as text boxes or means for selecting options in graphical user interfaces (GUIs) such as, but not limited to, menus, pull down menus, drag and drop between dialog boxes, list boxes and other selecting means (see, for example, C. Petzold, Programming Windows, ISBN 1-57231-995-X, Ch. 9, Ch. 10, Ch. 11, pp. 357-566, incorporated by reference herein).

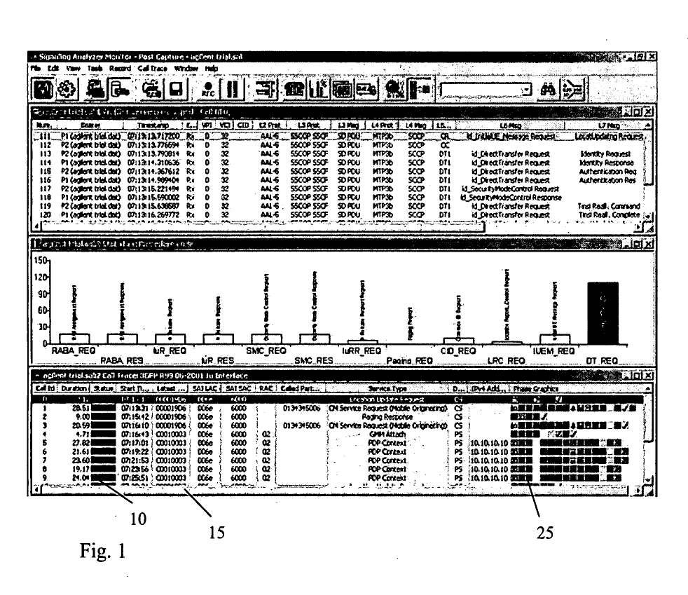

In order to elucidate the description of the user interface of this invention, a description of a user interface of a conventional signal (network) analysis system, wherein the acquired information includes communication events (signaling messages) from a network communications session, is presented below. A user interface of a conventional signal analysis system is shown in FIG. 1. Referring to FIG. 1, a number of summaries of data corresponding to a network communication session, each summary of data being depicted as identifying characteristics 10 and a graphical report 25, are displayed in a Call Trace window 15. A graphical report (phase graph view) 25, in which every symbol relates to a events (messages) for a single protocol, is displayed for every summary of data.

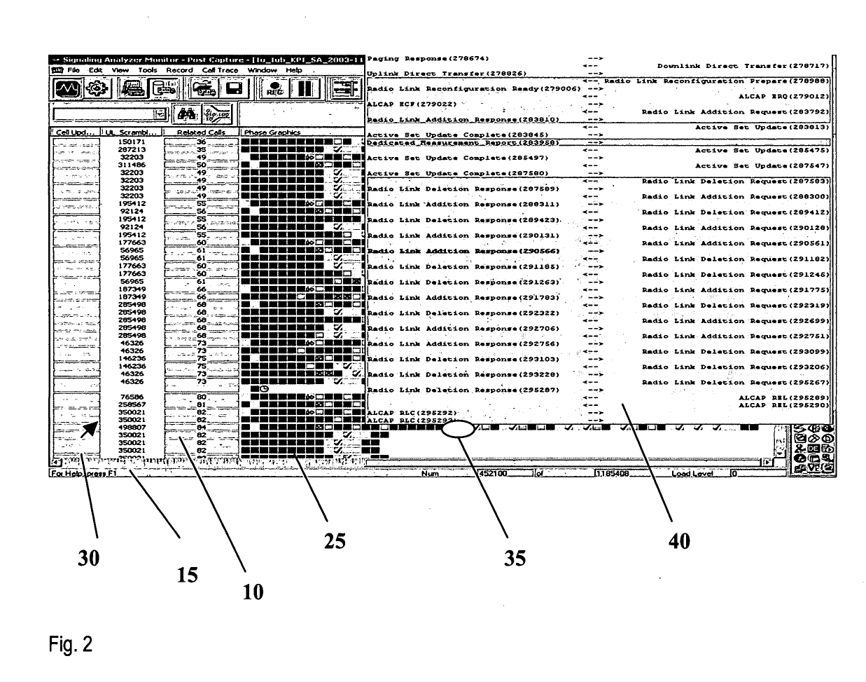

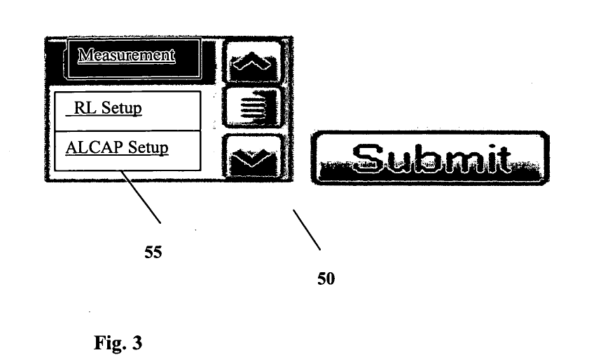

In an embodiment of the user interface of this invention, shown in FIG. 2, the user interface includes, in addition to the identifying characteristics 10 and a graphical report 25 for each summary of data, a component 30 that selects the communication event corresponding to a datum for each datum, another component (50, FIG. 3) that is capable of selecting a number of events corresponding to the selected summary of data and an icon 35 representing a portion of the graphical report corresponding to the selected events. The selected summary of data is depicted, using the user interface of this invention, as identifying characteristics 10, the icon 35 and a graphical report 25 reporting the non-selected events corresponding to the selected summary of data. In one embodiment, this invention not been limited only to this embodiment, the first component selects the one summary of data according to a predetermined criterion. In one instance, when there is significant activity in one summary of data resulting in a number of events exceeding a predetermined value, the summary is selected. In that instance, the selection process can take place in software or hardware. After acquisition and parsing of a summary of data, the number of events can be determined. The determining value can be set during system design or can be provided by the user. In another embodiment, the first component enables a user to select the one summary of data. In one instance, an embodiment of the first component is a cursor 30 and a mouse click function. In such an embodiment a user can select one summary of data by selecting it with a cursor followed by a mouse click (“right clicking”, for example). It should be noted that other embodiments for user input are within the scope of this invention (see, for example, C. Petzold, Programming Windows, ISBN 1-57231-995-X, Ch. 9, Ch. 10, Ch. 11, pp. 357-566). The second component, in one embodiment, consists of means of selecting a numbers of events corresponding to the selected one summary of data.

An exemplary embodiment, a list box 50 of the second component is shown in FIG. 3. Referring to FIG. 3, the user can select two procedures (protocols) from a list 55. Upon selecting the two procedures, all the events, corresponding to the selected one summary of data, between the two procedures are selected and are represented by the icon 35. Activating the icon 35 (for example, but not limited to, by “right clicking”) causes the display 40 of the selected events. It should be noted that other embodiments of the second component are within the scope of this invention (see, for example, C. Petzold, Programming Windows, ISBN 1-57231-995-X, Ch. 9, Ch. 10, Ch. 11, pp. 357-566)

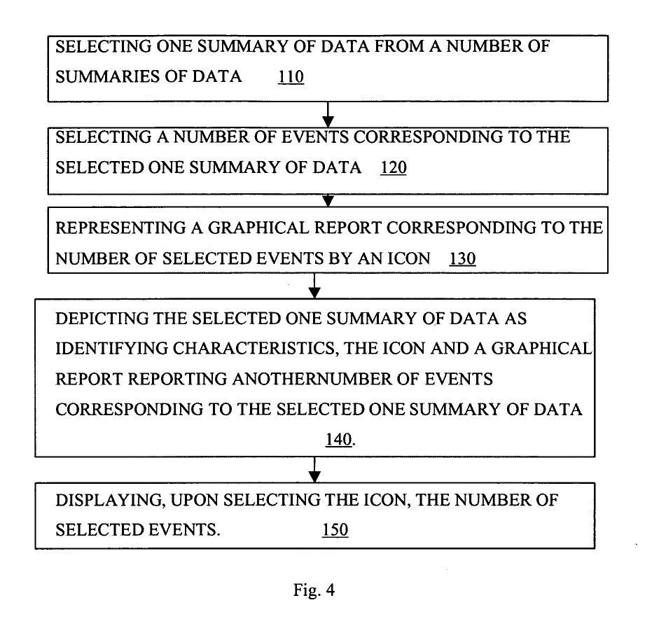

An embodiment of the method of this invention is shown in FIG. 4. Referring to FIG. 4, one summary of data from a number of summaries of data corresponding to a network communication session is selected (step 110, FIG. 4) and a number of events corresponding to the selected summary of data are selected (step 120, FIG. 4). A graphical report corresponding to the selected events is represented by an icon (step 130, FIG. 4) and the selected summary of data is depicted as identifying characteristics, the icon and a graphical report reporting the other non-selected events corresponding to the selected summary of data (step 140, FIG. 4). Another embodiment of the method of this invention includes the additional step of displaying, upon selecting the icon, the plurality of selected events (step 150, FIG. 4).

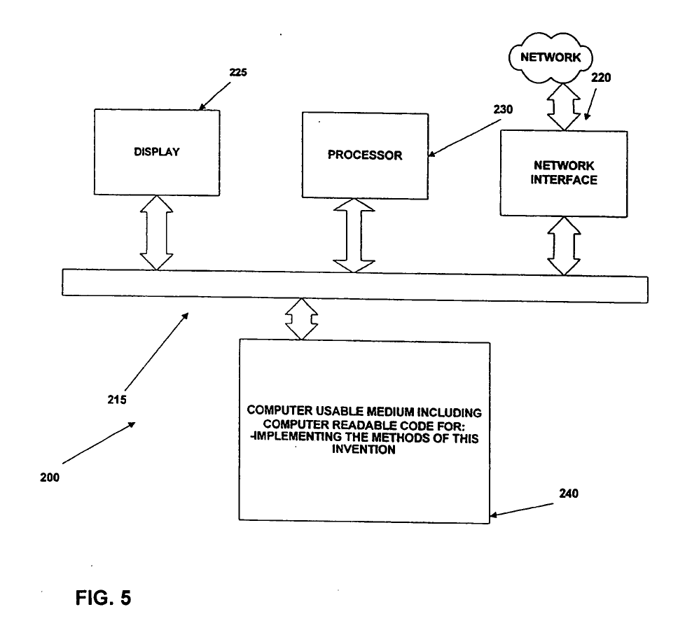

A schematic block diagram representation of an embodiment of the system of this invention is shown in FIG. 5. Referring to FIG. 5, the embodiment 200 of the system of this invention includes a network interface 220 capable of providing data corresponding to a communication session, a display 225, one or more processors 230, and one or more computer usable media 240 having computer readable code embodied therein. The computer readable code embodied in the one or more computer usable media 240 is capable of causing the one or more processors 230 to execute the method of this invention, including being capable of causing the one or more processors 120 to provide a user interface for depiction in the display device 140, the user interface comprising a component capable of selecting one summary of data from a number of summaries of data corresponding to the communication session, a component capable of selecting a number of events corresponding to the selected summary of data, and an icon representing a graphical report corresponding to the selected events. The computer readable code embodied in the one or more computer usable media 240 is also capable of causing the one or more processors 230 to display the selected summary of data as identifying characteristics, the icon and a graphical report reporting the non-selected events corresponding to the selected summary of data. In one instance, but not a limitation of this invention, the computer readable code, which causes the one or more processors 320 to provide the user interface, is generated starting from a higher-level language utilizing the application program interface (API) of the operating system being used (for example, but not limited to, the Windows API).

In one embodiment, the network interface 120 includes an acquisition component and a filtering component. The acquisition component can be similar, but is not limited to, to that found in signaling analyzers such as the “J7326A Signaling Analyzer” of AGILENT TECHNOLOGIES, Inc. The acquisition component and Filtering component receive the data from one or more transmission messages and renders the data in a form that can be provided to the one or more processors 130.

The network interface 220, the one or more processors 230, the display 235 and the computer usable medium 240 are operatively connected by means of a connection component 215 (the connection component may be, for example, a computer bus, or a carrier wave).

The techniques described above may be implemented in one or more computer programs executing on a programmable computer including a processor, a storage medium readable by the processor (including, for example, volatile and non-volatile memory and/or storage elements), and, in some embodiments, also including at least one input device, and/or at least one output device. Program code may be applied to data entered using the input device (or user interface) to perform the functions described and to generate output information. The output information may be applied to one or more output devices.

Elements and components described herein may be further divided into additional components or joined together to form fewer components for performing the same functions.

Each computer program may be implemented in any programming language, such as assembly language, machine language, a high-level procedural programming language, an object-oriented programming language, or a combination thereof. The programming language may be a compiled or interpreted programming language.

Each computer program may be implemented in a computer program product tangibly embodied in a computer-readable storage device for execution by a computer processor. Method steps of the invention may be performed by a computer processor executing a program tangibly embodied on a computer-readable medium to perform functions of the invention by operating on input and generating output.

Common forms of computer-readable (computer usable) media include, for example, a floppy disk, a flexible disk, hard disk, magnetic tape, or any other magnetic medium, a CDROM, any other optical medium, punched cards, paper tape, any other physical medium with patterns of holes or other patterns, a RAM, a PROM, and EPROM, a FLASH-EPROM, any other memory chip or cartridge, a carrier wave, such as electromagnetic radiation or electrical signals, or any other medium from which a computer can read.

Although the invention has been described with respect to various embodiments, it should be realized this invention is also capable of a wide variety of further and other embodiments within the spirit and scope of the appended claims.

What is claimed is:

1. A user interface for depicting on a display device, the user interface comprising:
a plurality of summaries of data corresponding to a network communication session, each summary of data from the plurality of summaries of data being depicted as identifying characteristics and a graphical report;
a component capable of selecting one summary of data from the plurality of summaries of data;
another component capable of selecting a plurality of events corresponding to said selected one summary of data; and
an icon representing a portion of said graphical report corresponding to said selected plurality of events;
said selected one summary of data being depicted as identifying characteristics, said icon and a graphical report reporting another plurality of events corresponding to said selected one summary of data.

2. The user interface of claim 1 wherein said icon enables displaying said plurality of selected events.

3. The user interface of claim 1 wherein said component capable of selecting one summary of data comprises a component capable of selecting said one summary of data according to a predetermined criterion.

4. The user interface of claim 1 wherein said component capable of selecting said one summary of data comprises a component enabling a user to select said one summary of data.

5. A computing device and associated display device, the computing device being programmed to implement the user interface of claim 1.

6. A computer readable medium having computer executable code embodied therein, said computer executable code being capable of causing a computer to implement the user interface of claim 1.

7. The computer readable medium of claim 5 where in said computer executable code is also capable of causing the computer to:
select said one summary of data according to a predetermined criterion.

8. The computer readable medium of claim 5 where in said computer executable code is also capable of causing the computer to:
select said one summary of data according to user input.

9. A method for displaying acquired signaling messages, the method comprising the steps of:
selecting one summary of data from a plurality of summaries of data corresponding to a network communication session;
selecting a plurality of events corresponding to said selected one summary of data;
representing a graphical report corresponding to said plurality of selected events by an icon; and
depicting said selected one summary of data as identifying characteristics, said icon and a graphical report reporting another plurality of events corresponding to said selected one summary of data.

10. The method of claim 9 wherein the step of selecting said one summary of data comprises a step of selecting said one summary of data according to a predetermined criterion.

11. The method of claim 9 wherein the step of selecting said one summary of data comprises a step of selecting said one summary of data according to user input.

12. The method of claim 9 further comprising the step of displaying, upon selecting the icon, said plurality of selected events.

13. A system for analyzing and displaying acquired signaling messages, the system comprising:
at least one processor;
a display device;
at least one computer usable medium having computer readable code embodied there in, said computer readable code being capable of causing said at least one processor to:
provide a user interface for depiction in the display device, the user interface comprising:
a component capable of selecting one summary of data from a plurality of summaries of data corresponding to a network communication session;
a component capable of selecting a plurality of events corresponding to said selected one summary of data; and
an icon representing a graphical report corresponding to said plurality of selected events;
display said selected one summary of data as identifying characteristics, said icon and a graphical report reporting another plurality of events corresponding to said selected one summary of data.

14. The system of claim 13 wherein said component capable of selecting one summary of data comprises a component capable of selecting said one summary of data according to a predetermined criterion.

15. The system of claim 13 wherein said component capable of selecting one summary of data comprises a component capable of selecting said one summary of data according to user input.

16. The system of claim 13 wherein said icon enables displaying said plurality of selected events.
